(19) United States
(12) Patent Application Publication
(10) Pub. No.: US 2006/0044781 A1
(43) Pub. Date: Mar. 2, 2006

(54) Bioluminescent fog for military and law enforcement

(76) Inventors: Brian Paul Hanley, Greenbrae, CA (US); Konstantin Gigitashvili, Tbilisi, GA (US)

Correspondence Address: Brian Hanley, 376 Via Hidalgo, Greenbrae, CA, 94904, US

(21) Appl. No.: 10/932,167

(22) Filed: Aug. 31, 2004

(51) Int. Cl. F21K 2/00

(52) U.S. Cl. 362/34

(57) ABSTRACT

This invention relates to the application of bioluminescence to the problem of illuminating an area at night without glare or shadows. By spraying a mist as fine droplets, which can penetrate into caves, crevices, bushes, and under trees, which are precisely the places where people hide in the dark, a glowing illumination can result as the droplets settle on and cling to surfaces. The material, which is invisible once it stops glowing, can also cling to people and their clothes, and when sprayed again with a reagent, will glow brightly until that reagent is again consumed.

### CROSS REFERENCE TO RELATED APPLICATIONS

| | | |
|---|---|---|
| 5,876,995 | Bryan | 1999 |
| 6,113,886 | Bryan | 2000 |
| 6,152,358 | Bryan | 2000 |
| 6,232,107 | Bryan | 2001 |
| 6,247,995 | Bryan | 2001 |
| 6,485,159 | Pitts | 2002 |
| 6,436,682 | Bryan | 2002 |

A number of patents exist for bioluminescence. And there are patents for luminescent illumination, in which the luminous substance is inside of a container. There are patents for spraying and dispersal as a novelty, as in a toy. There are no patents regarding bioluminescence for illumination for military or police use, in which the luminous material is applied outside of any container, directly as a spray or fog of droplets to an area or persons to be illuminated so as to cause the surfaces of those objects or persons in the area to become the source of illumination. There is a patent describing a convenient cassette for dosing multi-component luminescent materials into a squirt gun that is described. This invention makes reference to a cassette which would do substantially the same thing, enlarged and convenient for military or police use.

There is a great deal of prior art for delivery of chemicals by means of missiles, artillery shells or land mines. This patent concerns delivery of bioluminescent or chemical luminescent materials by any means to create as-needed localized illumination.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION—FIELD OF INVENTION

This invention relates to the application of bioluminescence to the problem of illuminating an area at night without glare or shadows. By spraying a mist as fine droplets, which can penetrate into caves, crevices, bushes, and under trees, which are precisely the places where people hide in the dark, a glowing illumination can result as the droplets settle on and cling to surfaces. The material, which is invisible once it stops glowing, can also cling to people and their clothes, and when sprayed again with a reagent, will glow brightly until that reagent is again consumed.

### BACKGROUND OF INVENTION—PRIOR ART

The genesis of this invention came with the observation that bioluminescence could be applied to an area as a spray or fog, and that this would result in the luminous fog or spray collecting on the surfaces it touched. I have not been able to identify any prior art in which luminous materials are sprayed in an area to illuminate it.

This invention is an integration of existing components and art in a new way, to achieve a highly important result in the field of military and law enforcement illumination. Accordingly, there are aspects of this invention which are novel and not obvious within the field of illumination.

### BACKGROUND OF INVENTION—OBJECTS AND ADVANTAGES

The overall object of the invention is to provide a means for illuminating a region composed of trees, bushes, crevices, caves, holes, rocks and the like. When luminescent agent is applied in the form of small droplets suspended in air, these droplets will settle out and cling to surfaces. This results in a unique form of illumination in which the surface of virtually every object within the region, living or not, becomes a source. This provides unique night-time illumination which has no shadows except those created by air currents favoring one side of an object or another.

Summary Advantages:

(a) To provide a mean of illumination of objects without generating shadows
(b) To provide a means of marking objects with the luminescent material such that they can be easily seen if they move outside of the region to which the spray or fog has been applied while it is dark.
(c) To apply this means of illumination with simple tools such as spray guns, easily broken polymer containers, fog generation machines and similar equipment that already exists.

### SUMMARY OF THE INVENTION

In accordance with the preferred embodiment of the invention, a fog or mist consisting of droplets containing bioluminescent material or a liquid containing this material. This fog or mist is applied by a variety of known means such as spray equipment, fog machines, mild explosive shells encased in light polymers. The material can be sprayed by hand, from manned or unmanned aircraft, from a truck, backpack, or delivered in a type of shell or container which could be hurled or fired. The liquid can be applied by spraying or by impact of a frangible container containing the material with an object.

### DRAWINGS—FIGURES

FIG. 1—Droplets composed of solvent, luminous material, substrate, gel

FIG. 2—Mist settling onto foliage and rocks

FIG. 3—Mist being applied with hand spray, artillery shell, missile, aircraft spray, land mine delivery.

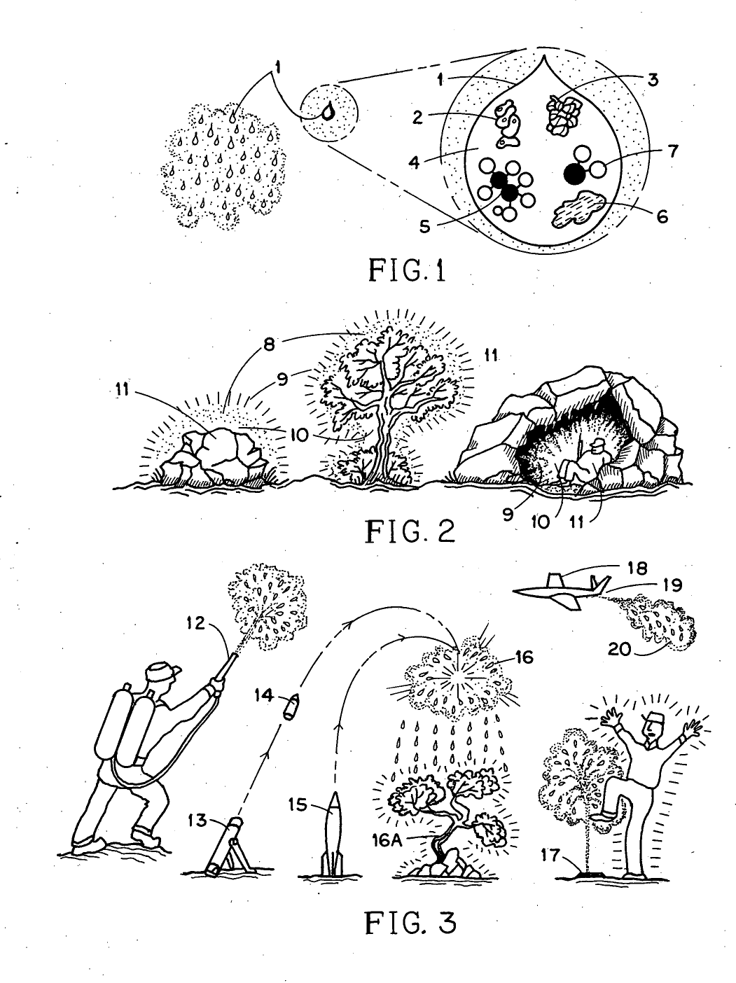

### DETAILED DESCRIPTION—FIGS. 1,2,3—PREFERRED EMBODIMENT

The mist system for illuminating objects FIG. 1 is composed of small droplets 1 which are usually 10-20 microns and larger in rough diameter. The mist should be composed of a range of droplet sizes, depending on how thorough the coverage of objects to be illuminated and the complexity of the objects. Larger droplets will tend to come out of suspension in the air more quickly than smaller ones will, and land at lower levels than smaller droplets. The droplets will generally be composed of solvent solution 4, composed of water represented by a ball and stick molecule 7, an alcohol or other solvent for fat soluble substances also represented by a ball and stick molecule 5, with a bioluminescent lighting compound 3, its consumable substrate 2, and some type of gel 6 in variable ratios.

The system for illumination of objects, FIG. 2 will include droplets suspended in air 8, droplets which have settled 10 on various objects 11, which objects are represented in this figure by a rock, a tree, a small bush behind the tree, the inside of a cave, and a man inside the cave. These droplets emit light 9 which illuminates the surface of the object and items within range of the light being emitted.

In the preferred embodiment FIG. 3, the mist 16 will be applied by various means. On the left is depicted a man using a spray backpack handheld sprayer 12. Alternatively, the material could be contained in a shell 14 perhaps fired from a mortar 13, which distributes its load of mist 16 to illuminate some object 16A at a distance. Similarly, a rocket containing a payload 15 could also distribute its mist 16 to illuminate an object 16A.

The mist system could be enclosed in a land mine type of device 17. When triggered, the person triggering the device could be immediately seen and tracked by guards. This would allow for the creation of a land mine system which would be useful in warfare, but nonlethal after soldiers have departed the area.

The mist system could be sprayed from an over flying aircraft 18. Emitted from a spray system 19 the mist 20 could be an aid to personnel on the ground or reconnaissance.

### FIGS. 3—ALTERNATIVE EMBODIMENTS

The invention can have alternative embodiments. The bioluminescent material could include an antibody component. This could allow the mist to either selectively illuminate, or to statistically enhance the illumination of certain elements of objects. For example, an antibody to wool could enhance the detection of blankets as are commonly used by guerillas in Central Asia to disguise themselves as rocks from the air. An antibody to cotton could operate similarly, and survive ordinary washing to some degree that occurs in the field. Used in this way such a system would be useful for identification of whether certain people or objects were ever located in the sprayed area.

The application means could be any means currently available for spreading pesticides and fertilizers such as aircraft spray equipment, tractor or truck based equipment, fog machines, paint spraying equipment. An applicator could be used such as a light polymer container with a small explosive at the center to disperse the droplets into the air at the desired location. An applicator could be used as simple as a balloon or pair of balloons or other containers which break open on impact, thereby illuminating the object in the area which is hit.

The application delivery could be made by means of a missile warhead, artillery shell, drone aircraft or aircraft, or a land mine type of device which would release a cloud of material into the air after being triggered. The material could be stored in cassettes of various sizes convenient for transport and deployment by military and police personnel.

### OPERATION

Operation of the device will be simple from a user's viewpoint. The user will place the bioluminous materials into the spray system. Then the user will spray it in the area which is desired to be illuminated. The spray mist will move into the area, settling on the objects the user wants to illuminate making them more visible.

### DESCRIPTION AND OPERATION OF ALTERNATIVE EMBODIMENTS

Where the luminous material incorporates an antibody, the user would simply use such an antibody containing material and apply in the same manner as any other. The benefit of the antibody form could be persistence, acting as a tagging agent to allow identification later of those who had been sprayed.

The user may apply the material as mist using an alternative method of application, such as a sprayer mounted on an aircraft, a balloon filled with the material or by firing a specially designed artillery shell containing the preparation. Or the user may apply the material by firing a missile, or by seeding an area with land mine style devices of various sizes.

Another alternative operation of the system is to apply only the luminescence catalyst, such as a marine luciferase enzyme in a gel, then later spray with the substrate that the luminescence catalyst consumes in separate steps. Substrate sprays could be reapplied as desired to continue to refresh the lighting in the area.

### CONCLUSION, RAMIFICATIONS AND SCOPE OF INVENTION

The invention has wide application for field use in illuminating battlefields in broken terrain or terrain filled with concealment such as brush, trees or jungle, as an alternative to use of flares, and for illuminating regions where a criminal suspect may have run to hide.

This system can provide an intermediate system for perimeter marking and response in the field that is an alternative to landmines. These luminous mines will be an improvement since the mines will not kill people directly, but instead guide soldiers to respond using their judgment during the active conflict. Thus, after seeding an area with such mines, when the conflict is over, the mines will be innocuous.

In the words of UNICEF:
“Of all the weapons that have accumulated over years of war, few are more persistent and more lethal to children. In 64 countries, where an estimated 110 million land-mines are lodged in the ground, children pick up or step on the devices while herding animals, working in the fields or just playing. Since many of the explosives look like toys, tops, pineapples or butterflies, children are drawn to them. In some areas, children scavenge mines for scrap metal.
Limbless and blind children around the world bear witness to the land-mine' path of destruction. Since 1975, the devices have killed or maimed more than 1 million people. They continue to kill 800 victims each month and disable more than 1,000 others. Many of today's land-mines, which can remain active for decades, were planted before their youngest victims were born.”

Thus, this invention applied to land mines could be very useful as an addition which could help to decrease the human cost of the aftermath of warfare.

This system can avoid the problems inherent with use of flashlights and floodlights to find someone in a brushy or forested area at night. Flashlights and floodlights cast dark shadows, which can lead to missing a person in hiding. They also inherently signal to those who are being hunted exactly where the source of lighting is located.

Additionally, it is expected that this invention will not be expensive to manufacture, and it can be applied with mostly existing technology.

1. A construct for field illumination consisting of:
(a) a bioluminescent or chemiluminescent substance
(b) an air suspension or spray of the substance in a solvent in the form of droplets such that it will blow, drift, or fall such that and when it comes into contact with objects, it will stick to them
(c) a method and means of applying the air suspension or spray
wherein the components are used in such a way as to illuminate a region or object, or else to tag a region or object for later opportunity to illuminate said region or object, or to tag for later illumination a plurality of regions or objects which may result from the application.

2. That the luminescent substance of the construct of claim 1 (a) may be a marine derived luciferase.

3. That the marine luciferase of claim 2 may require a substrate or substrates to consume, either singularly or as a plurality of substrates, which can also be applied either as a component of the spray, or applied later to cause the illuminated region to light up all surfaces to which it is applied.

4. That the luminescent material of claim 2 may be a Renilla mulleri luciferase, a Gaussia luciferase, a Pleuromamma luciferase or a plurality of luciferases which activate in combination with their substrate or a plurality of substrates.

5. That the suspension of claim 1(b) may be or contain a gel, hydrogel, microbeads, microbeads with digital tags, micro or nano scale transponders, miniscule amounts of explosives and combinations thereof which work together to optimize one or more of these characteristics:
(a) dispersion of droplet particles
(b) time suspended in air for a particular application
(c) ability to cling to a surface
(d) speed of reactants combining together
(e) changes to the light or patterns of light emitted
(f) ability to identify the source of a particular application

6. That the material of claim 1 (a) may incorporate an antibody to any substance, which results in the luminous material bonding to a favored surface to which it is exposed in such a way that it resists washing off.

7. That the substrate of claim 3 may be a coelenterazine which reacts with the marine luciferase and oxygen to evolve coelenteramide, carbon dioxide, and light.

8. That the luminous material of claim 1 (a) may consist of a luciferase or plurality of same combined with a non-biologically derived chemiluminescent compound or plurality of such compounds.

9. That the solvent of claim 1(b) may be water, an alcohol such as ethyl alcohol, methyl alcohol, isopropyl alcohol, or similar related alcohol, a hydrocarbon oil of any weight, a detergent, surfactant or soap, or any combination or permutation of any of the above singly or together.

10. That the construct of claim 1 may be delivered by means of any known spray system, such as those used for spraying crops from aircraft, from backpacks spray equipment, fog generation machines and the like.

11. That the construct of claim 1 may be delivered by missile warhead on a missile, artillery or mortar shell.

12. That the construct of claim 1 may be delivered by means of a land mine type of device.
